(19) United States
(12) Patent Application Publication
(10) Pub. No.: US 2021/0192970 A1
(43) Pub. Date: Jun. 24, 2021

(54) Systems, Devices, and/or Methods for Managing Learning Disabilities

(71) Applicant: Leah Davis, Churchville, VA (US)

(72) Inventor: Leah Davis, Churchville, VA (US)

(21) Appl. No.: 17/131,459

(22) Filed: Dec. 22, 2020

Related U.S. Application Data
(60) Provisional application No. 62/952,359, filed on Dec. 22, 2019.

(51) Int. Cl. G09B 19/00; G09B 1/06; G09B 1/28

(52) U.S. Cl. CPC G09B 19/00; G09B 1/28; G09B 1/06

(57) ABSTRACT

Certain exemplary embodiments can provide a device comprising a flexible core, the flexible core having a surface that acts to resist, but not to prevent, sliding of a plurality of objects thereon. Each of the plurality of objects is slidable along the core. The device comprises first end piece is coupled to a first end of the flexible core, wherein the plurality of objects cannot move past the first end piece.

### CROSS-REFERENCES TO RELATED APPLICATIONS

This application claims priority to, and incorporates by reference herein in its entirety, pending U.S. Provisional Patent Application Ser. No. 62/952,359 (Attorney Docket No. 1416-01), filed Dec. 22, 2019.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a perspective view of an exemplary set of devices 1000;

FIG. 2 is a perspective view of an exemplary set of devices 2000;

FIG. 3 is a perspective view of an exemplary embodiment of a device 3000;

FIG. 4 is a perspective view of an exemplary embodiment of a device 4000;

FIG. 5 is a perspective view of an exemplary embodiment of a device 5000;

FIG. 6 is a perspective view of an exemplary embodiment of a device 6000; and

FIG. 7 is a flowchart of an exemplary embodiment of a method 7000.

### DETAILED DESCRIPTION

Certain exemplary embodiments can provide a device comprising a flexible core, the flexible core having a surface that acts to resist, but not to prevent, sliding of a plurality of objects thereon. Each of the plurality of objects is slidable along the core. The device comprises first end piece is coupled to a first end of the flexible core, wherein the plurality of objects cannot move past the first end piece.

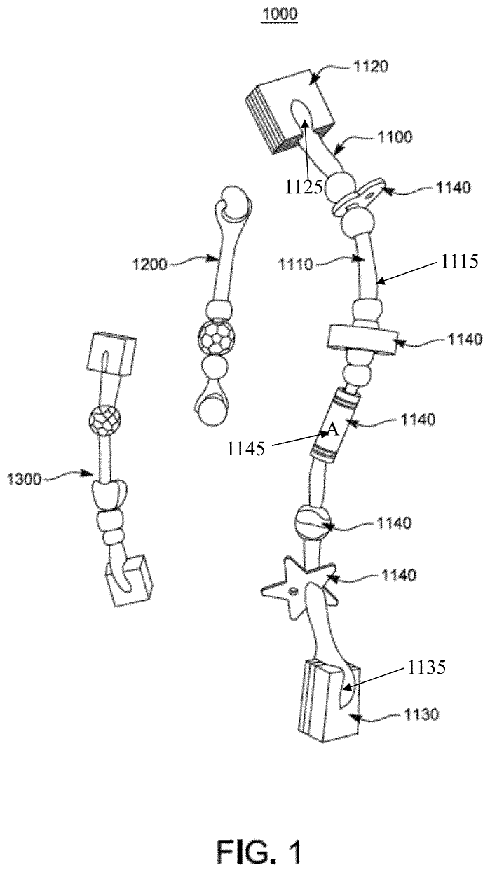

FIG. 1 is a perspective view of an exemplary set of devices 1000, which comprises a first device 1100, a second device 1200, and a third device 1300. First device 1100 comprises a flexible core 1110, a first end piece 1120, a second end piece 1130, and a plurality of objects 1140. First end piece 1120 and second end piece 1130 act as barriers to movement of plurality of objects 1140. Plurality of objects 1140 cannot move past either of first end piece 1120 or second end piece 1130. First end piece 1120 and second end piece 1130 are generally not coupleable to another device and/or system. Each of set of devices 1000 is constructed to be handheld by a person.

In certain exemplary embodiments, flexible core 1110 is constructed from a pipe cleaner or the like. In such embodiments, pipe cleaner bristles act to resist, but not prevent, motion of plurality of objects 1140 along the length of flexible core 1110.

Flexible core 1110 has a surface that resists, but does not prevent, sliding of plurality of objects 1140 thereon. Plurality of objects 1140 is slidable along flexible core 1110. Plurality of objects 1140 is selected to be aesthetically and/or tactilely interesting to a user. For example, one or more of plurality of objects 1140 can have a shape that is at least in part circular, spherical, cylindrical, rectangular, square, that of a star, that of a flower, that of a sports ball, that of a ribbon, and/or any other shape. As another example, one or more of plurality of objects 1140 can have an alphabetical letter and/or number written thereon. As another example, one or more of plurality of objects 1140 can have hard, smooth, soft, and/or fuzzy surfaces, etc.

Users can find devices such as set of devices 1000 fun and/or therapeutic. A user can touch and/or slide one or more of a plurality of objects (e.g., plurality of objects 1140 of first device 1100) to desired positions on a flexible core (e.g., flexible core 1110 of first device 1100). Sliding the plurality of objects can allow a user to count and/or maintain a count of something.

Devices such as set of devices 1000 can be particularly useful for developmentally impaired and/or disabled persons such as those that have a form of autism. Such individuals can utilize one or more of set of devices 1000 for educational and/or therapeutic purposes, such as learning to count. Users can also find the movement of the plurality of objects on the flexible core fun and/or recreational.

First device 1100 comprises:
flexible core 1110, which has a surface 1115 that acts to resist, but not to prevent, sliding of plurality of objects 1140 thereon;
each of plurality of objects 1140 is slidable along flexible core 1110;
first end piece 1120 is coupled to a first end 1125 of flexible core 1110, wherein plurality of objects 1140 cannot move past first end piece 1120; and
second end piece 1130 coupled to a second end 1135 of flexible core 1110, wherein plurality of objects 1140 cannot move past second end piece 1130.

Surface 1115 of flexible core 1110 can comprise bristles, such as pipe cleaner bristles. In certain exemplary embodiments, first end piece 1120 is not coupleable to another device. In certain exemplary embodiments, second end piece 1130 is not coupleable to another device. In certain exemplary embodiments, at least one of plurality of objects 1140 comprises an alphanumeric character (see, e.g., alphanumeric character 1145 of first device 1100).

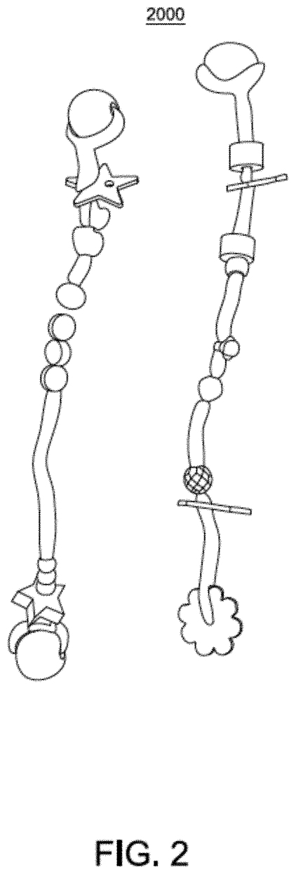

FIG. 2 is a perspective view of an exemplary set of devices 2000.

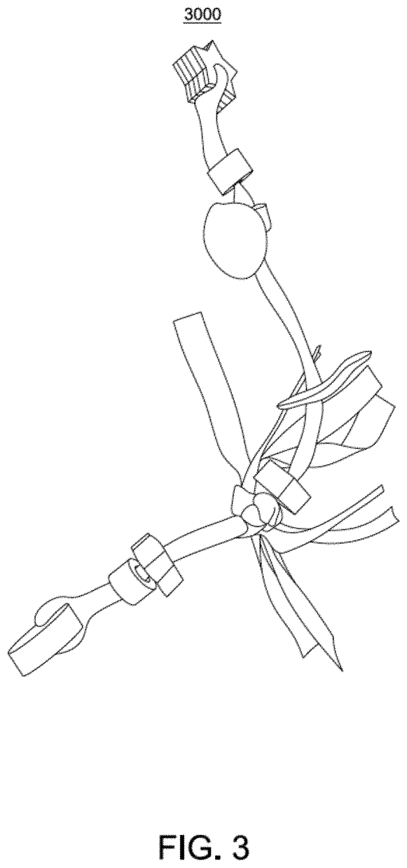

FIG. 3 is a perspective view of an exemplary embodiment of a device 3000.

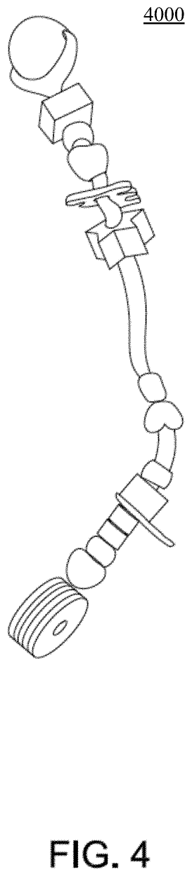

FIG. 4 is a perspective view of an exemplary embodiment of a device 4000.

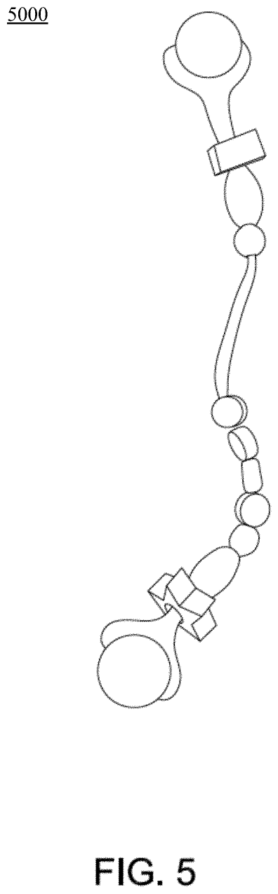

FIG. 5 is a perspective view of an exemplary embodiment of a device 5000.

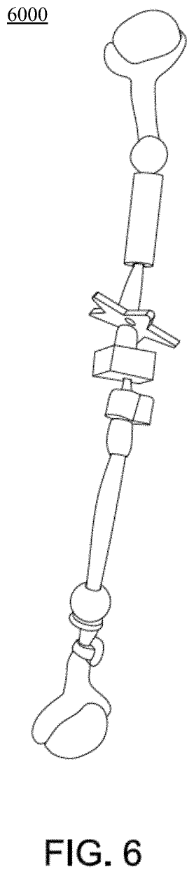

FIG. 6 is a perspective view of an exemplary embodiment of a device 6000.

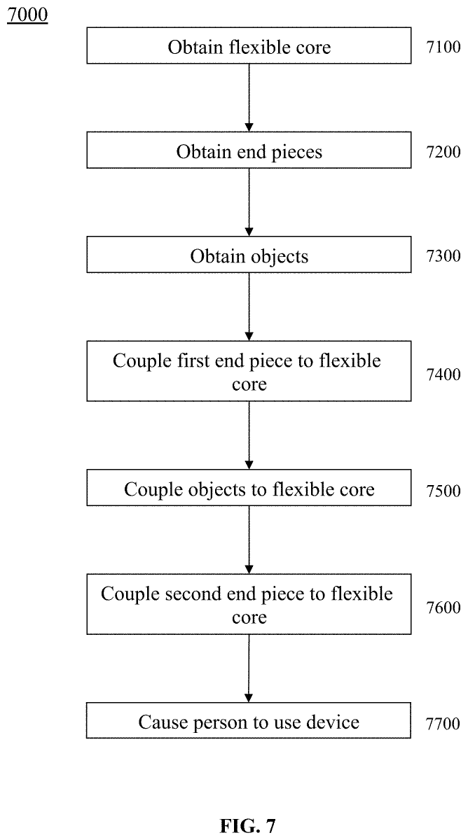

FIG. 7 is a flowchart of an exemplary embodiment of a method 7000. At activity 7100, a flexible core can be obtained. In certain exemplary embodiments, the flexible core can be a pipe cleaner. The flexible core has a first end and a second end. At activity 7200, end pieces can be obtained. At activity 7300, a plurality of objects can be obtained. At activity 7400, a first end piece can be coupled to the first end the flexible core. At activity 7500, the plurality of objects can be slidably coupled to the flexible core. At activity 7600, a second end piece can be coupled to the second end of the flexible core. Thereby, the plurality of objects cannot move past the first end piece and the second end piece.

At activity 7700, certain exemplary embodiments cause a developmentally impaired person to slide one of the plurality of objects coupled to the flexible core. The flexible core has a surface, such as a bristled surface of a pipe cleaner, that acts to resist, but not to prevent, sliding of the plurality of objects thereon. Each of the plurality of objects slidable along the core. The first end piece is coupled to the first end of the flexible core. The plurality of objects cannot move past the first end piece. The second end piece is coupled to a second end of the flexible core. The plurality of objects cannot move past the second end piece

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
act—to do something.
activity—an action, act, step, and/or process or portion thereof
adapter—a device used to effect operative compatibility between different parts of one or more pieces of an apparatus or system.
alphanumeric character—of a set of characters, the set of characters comprising letters and numbers.
and/or—either in conjunction with or in alternative to.
apparatus—an appliance or device for a particular purpose
associate—to join, connect together, and/or relate.
bristle—a fiber.
can—is capable of, in at least some embodiments.
cause—to bring about.
comprising—including but not limited to.
configure—to make suitable or fit for a specific use or situation.
connect—to join or fasten together.
constructed to—made to and/or designed to.
convert—to transform, adapt, and/or change.
core—a central portion of something.
couple—to link in some fashion.
coupleable—capable of being joined, connected, and/or linked together.
define—to establish the outline, form, or structure of
determine—to obtain, calculate, decide, deduce, and/or ascertain.
developmentally impaired person—a human that has at least one of a diverse group of chronic conditions that is due to mental or physical impairments. Developmental impairments cause individuals living with them many difficulties in certain areas of life, especially in language, mobility, learning, self-help, and independent living.
device—a machine, manufacture, and/or collection thereof.
end—a most extreme part of an object.
flexible—capable of bending without breaking.
install—to connect or set in position and prepare for use.
may—is allowed and/or permitted to, in at least some embodiments.
method—a process, procedure, and/or collection of related activities for accomplishing something.
move—to go or pass to another place or in a certain direction.
object—a tangible thing.
past—beyond.
piece—a part of a larger device or system.
pipe cleaner—an object comprising a flexible core around which bristles are coupled and which is constructed to clean a stem of a tobacco pipe.
plurality—the state of being plural and/or more than one.
predetermined—established in advance.
prevent—to keep something from occurring, such as keeping objects from moving on a surface.
provide—to furnish, supply, give, and/or make available.
receive—to get, take, acquire, and/or obtain.
repeatedly—again and again; repetitively.
resist—to oppose motion on a surface.
set—a related plurality.
slide—to move along a surface.
store—to place, hold, and/or retain.
substantially—to a great extent or degree.
support—to bear the weight of, especially from below.
surface—the outer boundary of an object or a material layer.
system—a collection of mechanisms, devices, machines, articles of manufacture, processes, data, and/or instructions, the collection designed to perform one or more specific functions.
via—by way of and/or utilizing.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A device comprising:
a flexible core, the flexible core having a surface that acts to resist, but not to prevent, sliding of a plurality of objects thereon;
the plurality of objects, each of the plurality of objects slidable along the flexible core;
a first end piece coupled to a first end of the flexible core, wherein the plurality of objects cannot move past the first end piece; and
a second end piece coupled to a second end of the flexible core, wherein the plurality of objects cannot move past the second end piece.

2. The device of claim 1, wherein:
the surface of the flexible core comprises bristles.

3. The device of claim 1, wherein:
the surface of the flexible core comprises pipe cleaner bristles.

4. The device of claim 1, wherein:
the first end piece is not coupleable to another device.

5. The device of claim 1, wherein:
the second end piece is not coupleable to another device.

6. The device of claim 1, wherein:
at least one of the plurality of objects comprises an alphanumeric character.

7. A method comprising a plurality of activities, comprising:
causing a developmentally impaired person to slide one of a plurality of objects comprised by a device, the device comprising:
a flexible core, the flexible core having a surface that acts to resist, but not to prevent, sliding of the plurality of objects thereon; and
the plurality of objects, each of the plurality of objects slidable along the core;
a first end piece coupled to a first end of the flexible core, wherein the plurality of objects cannot move past the first end piece; and
a second end piece coupled to a second end of the flexible core, wherein the plurality of objects cannot move past the second end piece.
